(19) United States
(12) Patent Application Publication
(10) Pub. No.: US 2007/0220327 A1
(43) Pub. Date: Sep. 20, 2007

(54) Dynamically Controlled Checkpoint Timing

(75) Inventors: Joseph Ruscio, Blacksburg, VA (US); Nicholas Jones, Blacksburg, VA (US)

Correspondence Address: MCDERMOTT WILL & EMERY LLP, 2049 CENTURY PARK EAST, 38th Floor, LOS ANGELES, CA, 90067-3208, US

(73) Assignee: EverGrid, Inc., a Delaware corporation

(21) Appl. No.: 11/535,431

(22) Filed: Sep. 26, 2006

Related U.S. Application Data
(60) Provisional application No. 60/776,161, filed on Feb. 23, 2006.

(51) Int. Cl. G06F 11/00

(52) U.S. Cl. 714/17

(57) ABSTRACT

The timing of one or more checkpoints that are recorded during execution of a computer process may be controlled based at least in part on the amount of one or more computer resources that are being used by the computer process. Related programs, systems and processes are also set forth.

### CROSS-REFERENCE TO RELATED APPLICATION

This application claims priority under 35 U.S.C. §119(e) from co-pending, commonly owned, U.S. provisional patent application Ser. No. 60/776,161, filed on Feb. 23, 2006, entitled “Method for Dynamically Sizing Checkpoint Intervals,” attorney docket no. 75352-015. The entire content of this provisional application is incorporated herein by reference.

### BACKGROUND

1. Technical Field

This application relates to computer systems and fault tolerance and, more specifically, to the timing of checkpoints.

2. Description of Related Art

Computer systems sometimes fail, resulting in the loss of information.

Fault tolerant systems may anticipate a failure by making a backup copy of information. If a failure occurs after the backup, the backup may be restored, thus reducing the amount of information that is lost.

Some computer systems process many operations at the same time, typically using a number of simultaneously operating processors. Computer application programs may be written specifically for these parallel-processing systems. These applications may request the processing of a large number of related processes simultaneously. They may also divide a large task into a set of such related processes.

Systems that simultaneously process numerous tasks can be particularly prone to fault problems, since the failure of any single sub-processing system may affect the integrity of the entire application. As a consequence, it may be necessary to back up information concerning all of the processes that are being simultaneously executed, just to protect against the failure of any single one of them.

Computer systems that provide parallel-processing capabilities often include a backup technology that repeatedly takes snapshots of state information while the system is operating normally. These snapshots are often referred to as “checkpoints.”

Taking checkpoints, however, may consume valuable processing time. They may also delay completion of other processes that are running. Taking frequent checkpoints, therefore, may be costly and disruptive. Taking infrequent checkpoints, on the other hand, may increase costs and problems after a fault takes place, by requiring more time to be spent reconstructing the information that was entered or developed after the last checkpoint.

It can be challenging to optimize the frequency of checkpoints.

One approach utilizes a user that manually issues a command to the system whenever a checkpoint is desired. This approach, however, can be costly, as a person must normally be employed to perform the task. This approach may also be prone to errors, as the process is performed manually by a person who may make mistakes.

Another approach adds coding to the application that dictates when each checkpoint is to be taken. However, it can be difficult to anticipate the optimum times for taking checkpoints during the coding stage. Also, it may not be feasible to add coding to some applications.

Another approach has a compiler analyze the source code of the application and insert appropriate checkpoint commands. Again, however, optimizing checkpoints may be difficult and the source code may not always be available.

A still further approach takes checkpoints at a predetermined interval. Again, however, it may be difficult to predict the optimal interval.

### SUMMARY

The timing of one or more checkpoints that are recorded during execution of a computer process may be controlled based at least in part on the amount of one or more computer resources that are being used by the computer process.

Related programs, systems and processes are also set forth.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 illustrates components of a computing system that may be used in connection with checkpoint operations.

FIG. 2 illustrates processes that may be spawned from an application.

FIG. 3 illustrates communications that may take place between a checkpoint library and a checkpoint management system.

FIG. 4 illustrates a resource usage report.

FIG. 5 illustrates an alternate embodiment of checkpoint management communications.

### DETAILED DESCRIPTION OF ILLUSTRATIVE EMBODIMENTS

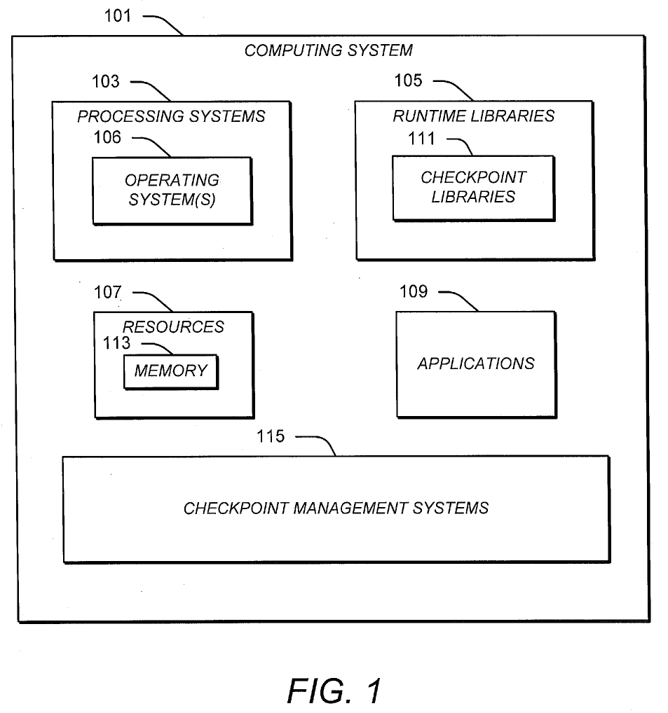

FIG. 1 illustrates components of a computing system that may be used in connection with checkpoint operations. As shown in FIG. 1, a computing system 101 may include one or more processing systems 103, one or more runtime libraries 105, resources 107, one or more applications 109, and one or more checkpoint management systems 115.

The computing system 101 may be any type of computing system. It may be a standalone system or a distributed system. It may be a single computer or multiple computers networked together.

Any type of communication channel may be used to communicate between the various components of the computing system 101, including busses, LANs, WANs, the Internet or any combination of these.

Each of the processing systems 103 may be any type of processing system. Each may consist of only a single processor or multiple processors. When having multiple processors, the processors may be configured to operate simultaneously on multiple processes. Each of the processing systems 103 may be located in a single computer or in multiple computers. Each of the processing systems 103 may be configured to perform one or more of the functions that are described herein and/or different functions.

Each of the processing systems 103 may include one or more operating systems 106. Each of the operating systems 106 may be of any type. Each of the operating systems 106 may be configured to perform one or more of the functions that are described herein and/or different functions.

Each of the applications 109 may be any type of computer application program. Each may be adopted to perform a specific function or to perform a variety of functions. Each may be configured to spawn a large number of processes, some or all of which may run simultaneously. Examples of applications that spawn multiple processes that may run simultaneously include oil and gas simulations, management of enterprise data storage systems, algorithmic trading, automotive crash simulations, and aerodynamic simulations.

The resources 107 may include resources that one or more of the applications 109 use during execution.

The resources may include a memory 113. The memory 113 may be of any type. RAM is an example. The memory 113 may include caches that are internal to processors that may be used in the processing systems 103. The memory 113 may be in a single computer or distributed across many computers at separated locations.

The resources 107 may include support for inter-process communication (IPC) primitives, such as support for open files, network connections, pipes, message queues, shared memory, and semaphores. The resources 107 may be in a single computer or distributed across multiple computer locations.

The runtime libraries 105 may be configured to be linked to one or more of the applications 109 when the applications 109 are executing. The runtime libraries 105 may be of any type, such as I/O libraries and libraries that perform mathematical computations.

The runtime libraries 105 may include one or more checkpoint libraries 111. Each of the checkpoint libraries 111 may be configured to intercept calls for resources from a process that is spawned by an application to which the checkpoint library may be linked, to allocate resources to the process, and to keep track of the resource allocations that are made. The checkpoint libraries 111 may also be configured to cause checkpoints to be recorded at different times during execution of the process. These checkpoints may be triggered by code within the checkpoint libraries 111 and/or by requests from outside processes, examples of which will be described below. The checkpoint libraries 111 may be configured to perform other functions, including the other functions described herein.

Each of the checkpoint management systems 115 may be configured to control the timing of checkpoints taken by one or more of the checkpoint libraries 111. Examples of ways in which these controls may be triggered are discussed below.

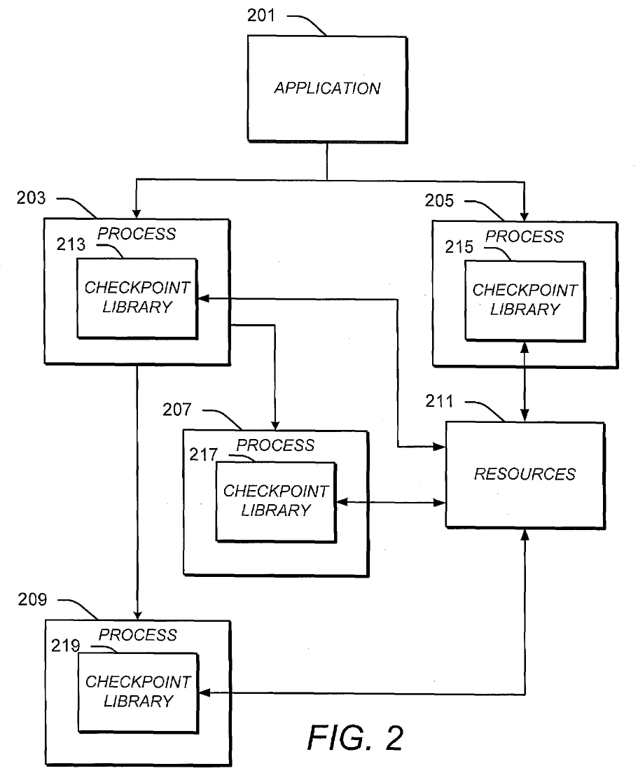

FIG. 2 illustrates processes that may be spawned from an application. As shown in FIG. 2, an application 201 may spawn several processes during execution, such as a process 203 and a process 205 The application 201 may be one of the applications 109 shown in FIG. 1. When operating in a parallel-processing environment, these processes may be performed simultaneously, such as by one of the processing systems 103.

One or more of the processes that are spawned by the application 201 may, in turn, spawn their own processes. For example, the process 203 may spawn a process 207 and a process 209 during execution. The spawning of processes by the application 201 and/or by one or more of the processes that have been spawned by it may continue throughout the execution of the application 201.

The spawned processes 203, 205, 207, and 209 may share resources, such as resources 211. The resources 211 may be of the same type as the resources 107 shown in FIG. 1.

When each process is spawned, it may link to one or more runtime libraries, such as to one or more of the runtime libraries 105 in FIG. 1. One of these linked libraries may be a checkpoint library. For example, a checkpoint library 213 may be linked to the process 203, a checkpoint library 215 may be linked to the process 205, a checkpoint library 217 may be linked to the process 207, and a checkpoint library 219 may be linked to the process 209.

Each of the checkpoint libraries 213, 215, 217 and 219 may be a replica of one of the checkpoint libraries 111 shown in FIG. 1. Alternatively, one or more of the checkpoint libraries 213, 215, 217 and 219 may contain instructions different from the others.

Each of the checkpoint libraries 213, 215, 217 and 219 may be configured to receive requests from the process to which it is linked for resources, to allocate these resources to the process, and to track the allocations that it makes. Each of the checkpoint libraries 213, 215, 217 and 219 may also be configured to record checkpoints at various times, as well as provide other functions, including the other functions described herein.

Various information may be recorded during each checkpoint by each checkpoint library. This information may include, for example, data in memory that is being used by the process to which the checkpoint library is linked, the location of the instruction that is being executed at the time of the checkpoint, open file handles, etc. During certain checkpoints, each checkpoint library may be configured to record only the data in memory that has changed since the last checkpoint. Other types of information may be recorded in addition or instead.

Each checkpoint library may similarly be configured to track various information about the resources 211 that a process linked to the checkpoint library is using. For example, each checkpoint library may be configured to track the amount of memory being used, the amount of shared memory being used, the amount of changes to memory since the last checkpoint, and/or the number of network connections, pipes, message queues, open files, and/or semaphores. Other types of information may be tracked in addition or instead.

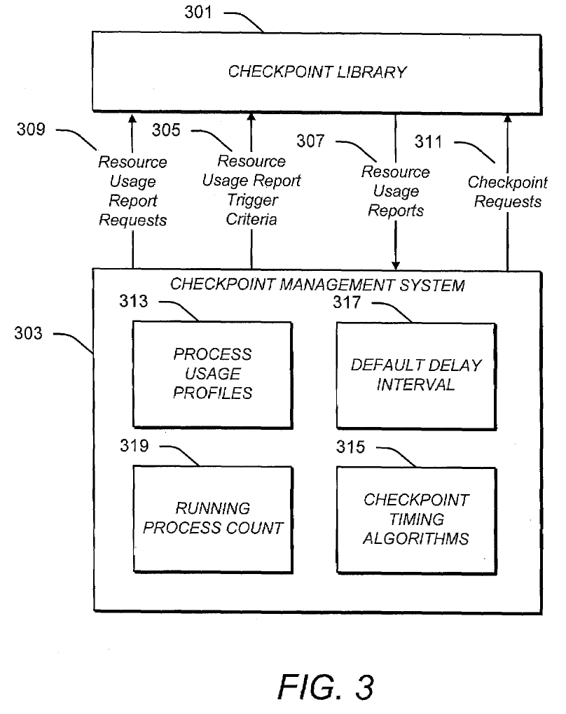

FIG. 3 illustrates communications that may take place between a checkpoint library and a checkpoint management system.

As shown in FIG. 3, a checkpoint management system 303 may communicate with a checkpoint library 301. The checkpoint management system 303 may be one of the checkpoint management systems 115 shown in FIG. 1, and the checkpoint library 301 may be one of the checkpoint libraries 213, 215, 217 or 219 that are shown in FIG. 2.

The checkpoint management system 303 may issue resource usage report requests 309 to the checkpoint library 301 The checkpoint library 301 may interpret each of the resource usage report requests 309 as a request that seeks resource usage reports. In response, the checkpoint library 301 may return resource usage reports 307 to the checkpoint management system 303, each in response to a request.

The resource usage reports 307 may each include information about the usage of resources by the process to which the checkpoint library 301 may be linked, such as about the usage of the resources 211 by the process 203.

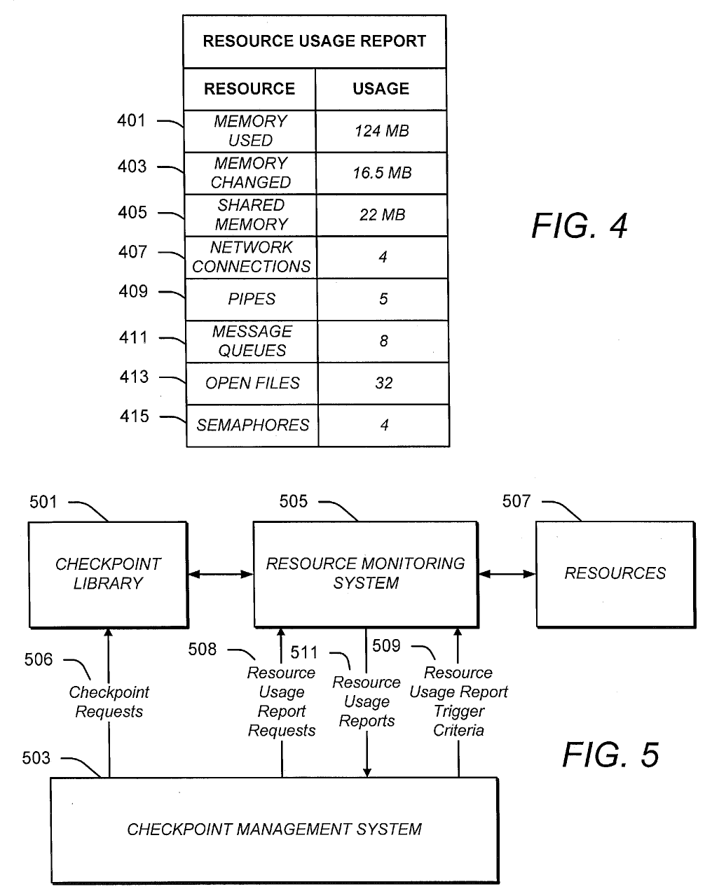

FIG. 4 illustrates a resource usage report. Such a report may be one of the resource usage reports 307. As shown in FIG. 4, the resource usage report may include information about the resources that the process to which the checkpoint library 301 may be linked is using, such as memory used 401, memory changed 403, shared memory 405, network connections 407, pipes 409, message queues 411, open files 413 and semaphores 415. The resource usage report may contain usage information that is different from what is illustrated.

The checkpoint management system 303 may deliver resource usage report trigger criteria 305 to the checkpoint library 301. The resource usage report trigger criteria 305 may specify one or more resource usage criteria which, when determined to have been met by the checkpoint library 301, cause the checkpoint library 301 to issue one of the resource usage reports 307. This may relieve the checkpoint management system 303 from having to constantly request resource usage reports from the checkpoint library 301 by making checkpoint requests. It may also relieve it of the burden of constantly analyzing resource usage reports that may not be of importance.

The checkpoint management system 303 may specify the resource usage report trigger criteria 305 so that it only causes the checkpoint library 301 to deliver resource usage reports when they are likely to be important. For example, the checkpoint management system 303 may specify the resource usage report trigger criteria 305 to trigger reports only when the amount of memory that has been changed by the process associated with the checkpoint library 301 since the last checkpoint is below a threshold. The checkpoint management system 303 may in addition or instead specify the resource usage report trigger criteria 305 to trigger reports only when the usage of other resources, such as shared memory, network connections, pipes, message queues, open files, and/or semaphores, falls below a threshold amount. The checkpoint management system 303 may specify the resource usage report trigger criteria 305 to be a logical combination of one or more of these criteria, as well as other criteria.

The checkpoint management system 303 may deliver one or more checkpoint requests 311 to the checkpoint library 301. The checkpoint library 301 may be configured to record a checkpoint upon receipt of each checkpoint request.

The checkpoint management system 303 may store various types of information to aid in its operation. For example, the checkpoint management system 303 may store one or more process usage profiles 313. Each of the process usage profiles 313 may contain historical information about the use of one or more resources by a process, such as information reflecting a pattern of such usage.

The checkpoint management system 303 may develop each of the process usage profiles 313 based on one or more of the resource usage reports 307 that come from the checkpoint library 301 that is associated with the process. The process profiles 313 may be copies of the resource usage reports 307 and/or representative of an analysis of one or several of them.

The checkpoint management system 303 may include one or more checkpoint timing algorithms 315. Each of these algorithms, or a plurality of them in cooperation, may control the times when the checkpoint management system 303 issues one or more of the checkpoints requests 311 to the checkpoint library 301.

Any type of algorithm may be used and any type of information may be considered by an algorithm in determining when one of the checkpoint requests 311 should be issued. One of the algorithms 315 may cause checkpoint requests 311 to be issued based on one or more of the resource usage reports 307 and/or one or more of the process profiles 313. For example, one of the algorithms 315 may cause checkpoint requests 311 to be issued each time one of the resource usage reports 307 advises that its associated process has only changed a small amount of its allocated memory since the last checkpoint.

One of the algorithms 315 may consult with one or more of the process profiles 313 to determine whether one or more of the resource usage values in one or more of the resource usage reports 307 indicate that the process associated with the report is at a peak or low of a resource usage point. If indicative of a peak, one of the algorithms 315 may be configured to defer issuance of one of the checkpoint requests 311. Conversely, if at a low, one of the algorithms 315 may be configured to immediately issue or at least accelerate the issuance of one of the checkpoint requests 311.

One of the algorithms 315 may be configured to make determinations about the issuance of the checkpoint requests 311 based on a single factor or a logical combination of several factors. One or more threshold values may also be used.

The checkpoint management system 303 may include a default delay interval 317. This may represent a pre-programmed interval at which the checkpoint management system 303 should deliver the checkpoint requests 311. One of the algorithms 315 may consult the default delay interval 317 for the purpose of deciding on exactly when to issue the checkpoint requests 311. If one or more of the resource usage reports 307 indicate that a process is using a typical amount of resources, for example, one of the algorithms 315 may issue the next one of the checkpoints requests 311 upon expiration of the default delay interval 317. If the resource usage is higher or lower than is typical, on the other hand, one of the algorithms 315 may make a corresponding adjustment in this interval. One of the algorithms 315 may adjust the interval between each of the checkpoint requests 311, the point in time when any one of the checkpoint requests 311 is issued, or both.

One of the algorithms 315 may be configured to issue the resource usage report requests 309 and to analyze the resource usage reports 307 that are delivered in response when determining when to issue the checkpoint requests 311. The algorithm may do so, even when relying upon the process profiles 313 and/or the default delay interval 317.

One of the algorithms 315 may be configured to automatically update the resource usage report trigger criteria 305 based on one or more of the resource usage reports 307, one or more of the process profiles 313, the default delay interval 317, and/or other criteria. Based on an analysis of this information or any portion of it, for example, an algorithm may determine that the previously delivered resource usage report trigger criteria 305 is not optimum, causing the checkpoint management system 303 to receive resource usage reports 307 too frequently or infrequently. The algorithm may revise the criteria and cause the checkpoint management system 303 to issue the revised criteria.

The checkpoint management system 303 may be configured to communicate in the same or a different way with a plurality of checkpoint libraries, each of which may be linked to a different process spawned from the same running application. The process profiles 313 may include profiles of a plurality of processes, and the number of active processes may be stored in a running process count 319.

One of the checkpoint timing algorithms 315 may be configured to take into consideration an aggregation of resource usage information about all or several of the running processes in determining when one or more of the checkpoint requests 311 should be sent. The information may include information in one or more of the process profiles 313, the running process count 319, and/or one or more of the resource usage reports 307. The algorithm may then cause the checkpoint management system 303 to issue checkpoint requests 311 to all of running checkpoint libraries at times that are determined based on this aggregated information.

Examples of aggregated information that may be relied upon in deciding when to issue checkpoint requests 311 include the amount of data that has been changed in the memory 113 by all of the running processes since the last checkpoint, the amount of memory that all of the processes are using, and/or the number of running processes. The amount of inter-process communication (IPC) primitives being used by all of the process may also be aggregated and considered, including open files, network connections, pipes, message queues, shared memory, and semaphores. And again, any single piece of information or logical combination of information may be used by one of the checkpoint timing algorithms 315 in determining when to issues the checkpoint requests 311. One of the checkpoint timing algorithms 315 may also cause one or more resource usage report requests 309 to be issued to one or more of the running processes at appropriate times. The resource usage reports 307 sent in response may be considered as part of the evaluation.

Communications between the checkpoint library 301 and the checkpoint management system 303 may be by any means and inter-process communication (IPC) primitives may be used. For example, a TCP socket may be used which the associated application has registered for asynchronous or synchronous I/O notification.

FIG. 5 illustrates an alternate embodiment of checkpoint management communications. As shown in FIG. 5, a checkpoint library 501 may communicate with a checkpoint management system 503, both of which may communicate with a resource monitoring system 505. The resource monitoring system 505 may communicate with one or more resources 507.

This configuration is similar to the configuration illustrated in FIG. 3, in that checkpoint requests 506 may be delivered from the checkpoint management system 503 to the checkpoint library 501. It differs from the configuration shown in FIG. 3, however, in that the resource monitoring system 505 may monitor the resources being used by the checkpoint library 501 while being external to the checkpoint library 501. In this configuration, resource usage report requests 508, resource usage report trigger criteria 509, and resource usage reports 511 may be communicated between the checkpoint management system 503 and the resource monitoring system 505, not between the checkpoint management system 503 and the checkpoint library 501. Except for this difference, the checkpoint library 501, the checkpoint management system 503, and the resources 507 may be the same as discussed above in connection with the checkpoint library 301, the checkpoint management system 303, and the resources 211, respectively.

The resource monitoring system 505 may be a separate program or part of an existing program. For example, the resource monitoring system 505 may be part of one or more of the operating systems 106.

The various components that have been described may be comprised of hardware, software, and/or any combination thereof. For example, the checkpoint management systems, the checkpoint libraries, the resource monitoring system and the applications may be software computer programs containing computer-readable programming instructions and related data files. These software programs may be stored on storage media, such as one or more floppy disks, CDs, DVDs, tapes, hard disks, PROMS, etc. They may also be stored in RAM, including caches, during execution.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently. In short, the scope of protection is limited solely by the claims that now follow. That scope is intended to be as broad as is reasonably consistent with the language that is used in the claims and to encompass all structural and functional equivalents.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts.

Nothing that has been stated or illustrated is intended to cause a dedication of any component, step, feature, object, benefit, advantage, or equivalent to the public, regardless of whether it is recited in the claims.

We claim:

1. Storage media containing computer-readable instructions that control the timing of one or more checkpoints recorded during execution of a computer process based at least in part on the amount of one or more computer resources that are being used by the computer process.

2. The storage media of claim 1 wherein the computer-readable instructions control the timing based at least in part on an amount of memory that the computer process has changed since a previous checkpoint.

3. The storage media of claim 1 wherein the computer-readable instructions control the timing based at least in part on an amount of memory that the computer process is using.

4. The storage media of claim 1 wherein the computer-readable instructions control the timing based at least in part on an amount of inter-process communication primitives that the computer process is using.

5. The storage media of claim 4 wherein the computer-readable instructions control the timing based at least in part on an amount of at least one of the following that the computer process is using: open files, network connections, pipes, message queues, shared memory, and semaphores.

6. The storage media of claim 1 wherein the computer-readable instructions control the timing based at least in part on a history of the usage of the one or more computer resources by the computer process.

7. The storage media of claim 6 wherein the computer-readable instructions control the timing based on an analysis of a plurality of reports about the usage of the one or more computer resources by the computer process.

8. The storage media of claim 1 wherein the computer-readable instructions control the timing of one or more checkpoints recorded during execution of a plurality of processes based at least in part on the aggregated amount of one or more computer resources that are been used by the processes.

9. The storage media of claim 8 wherein the computer-readable instructions control the timing based at least in part on the aggregated amount of one or more computer resources that are been used by processes spawned by a single computer application program.

10. The storage media of claim 1 wherein the computer-readable instructions control the timing based on a default delay interval.

11. The storage media of claim 10 wherein the computer-readable instructions cause the default delay interval to be adjusted based on the usage of the one or more computer resources by the computer process.

12. The storage media of claim 1 wherein the computer-readable instructions cause the issuance of one or more requests for a report on the usage of the one or more computer resources by the computer process.

13. The storage media of claim 12 wherein the computer-readable instructions cause at least one of the requests to be issued to a checkpoint runtime library that is linked to the computer process.

14. The storage media of claim 1 wherein the computer-readable instructions cause the delivery of a resource usage report trigger criteria that specifies criteria as to when a report about the usage of the computer resources by the computer process should be issued.

15. The storage media of claim 14 wherein the computer-readable instructions cause the delivery of the resource usage report trigger criteria to a checkpoint runtime library that is linked to the computer process.

16. The storage media of claim 14 wherein the computer-readable instructions cause the resource usage report trigger criteria to be modified based on the usage of the one or more computer resources by the computer process.

17. Storage media containing computer-readable instructions that cause checkpoints relating to an executing computer process that is linked to the instructions to be recorded and that issue reports about usage of one or more computer resources by the executing computer process.

18. The storage media of claim 17 wherein the computer-readable instructions receive resource usage report trigger criteria that specify criteria as to when the report about the usage of the one or more computer resources by the computer process should be issued and cause the issuance of the report when the criteria is satisfied.

19. The storage media of claim 17 wherein the computer-readable instructions cause the issuance of a report about an amount of memory that the computer process has changed since a previous checkpoint.

20. The storage media of claim 17 wherein the computer-readable instructions are configured as a runtime library that may be linked at runtime to the computer process.

21. A computing system containing a checkpoint management system configured to control timing of one or more checkpoints taken during execution of a computer process based at least in part on usage of one or more computer resources by the computer process.

22. A computing system containing a checkpoint library configured to issue a report about usage of one or more computer resources by a computer process that is linked to the checkpoint library and to cause checkpoint data relating to the executing computer process to be recorded.

23. A fault-tolerance process, comprising issuing a request for recordation of checkpoint data during execution of a computer process based at least in part on usage of one or more computer resources by the computer process.

24. A fault-tolerant process, comprising determining whether the amount of use of one or more computer resources by a computer process meets or passes a threshold and, based thereon, issuing a report about the usage.
